(19) United States
(12) Patent Application Publication
(10) Pub. No.: US 2010/0257287 A1
(43) Pub. Date: Oct. 7, 2010

(54) DATA LOGGER

(75) Inventors: Alois BISCHOF, Gams (CH); Beat Rudolf, Landquart (CH)

Correspondence Address: BUCHANAN, INGERSOLL & ROONEY PC, POST OFFICE BOX 1404, ALEXANDRIA, VA, 22313-1404, US

(73) Assignee: ELPRO-Buchs AG, Buchs (CH)

(21) Appl. No.: 12/817,867

(22) Filed: Jun. 17, 2010

Related U.S. Application Data
(63) Continuation of application No. PCT/CH2008/000432, filed on Oct. 15, 2008.

(30) Foreign Application Priority Data
Dec. 19, 2007 (CH) 1973/07

(51) Int. Cl. G06F 17/40; G06F 13/20; G06F 3/00

(52) U.S. Cl. 710/16; 710/313; 702/187

(57) ABSTRACT

A data logger for collecting, evaluating and displaying data, such as climate data, generated from measured values is disclosed, which has different function units within a common hardware housing. These units include a collection unit, a storage unit and a control and evaluation unit which is connected to the other units. A USB interface for digital data exchange with an external data processing system is included on the housing. The USB interface can be operated both as a digital interface for digital data exchange, and as an analog interface for receiving analog measurement signals.

### RELATED APPLICATIONS

This application claims priority as a continuation application under 35 U.S.C. §120 to PCT/CH2008/000432, which was filed as an International Application on Oct. 15, 2008 designating the U.S., and which claims priority to Swiss Application 1973/07 filed in Switzerland on Dec. 19, 2007. The entire contents of these applications are hereby incorporated by reference in their entireties.

### FIELD

The disclosure relates to data logging, such as data loggers for collecting, evaluating and displaying climate data generated from measured values.

### BACKGROUND INFORMATION

Electronic devices, so-called data loggers, are used wherever long-term recording of measurement parameters is to be done without monitoring personnel being continuously present on site. Thus, data loggers are used mainly in field trials, in the monitoring of transports, for example in the monitoring of acceleration data, vibration data and climate data in truck or rail transports, for recording of humidity and temperature values in warehouses, in the pharmaceutical and foodstuffs industry, for fault analysis of systems, for example for detection of voltage fluctuations in or on a system, for monitoring and alerting in production processes and in quality studies, in research, development and in education. Data loggers are also used for recording and monitoring of measurement data in the hobby domain, for example in model airplanes.

The measurement data which have been collected and stored over a longer time interval can be further processed if desired, can be graphically displayed and statistically evaluated for documentation. In addition to the measurement data, data loggers also often detect all events, such as for example, battery changing, operator intervention or changing of a memory card, which occur on the device during a monitoring interval. Thus, these data loggers also meet the specifications of the pharmaceutical, foodstuffs and chemical industry which are imposed, for example, under GLP (good laboratory practice), GMP (good manufacturing practice) or under FDA standards. The measurement data collected by the data logger are filed in an internal hardware storage and can be retrieved if necessary.

Known data loggers have a digital interface, for example a USB interface for digital data exchange with an external PC or the like and at least one analog interface to which, for example, a sensor for temperature measurement (e.g., a temperature-dependent resistance) can be connected. Providing several interfaces dictates a correspondingly large housing. But on the other hand, when used for monitoring of climate data there is a desire for more and more manageable and smaller data loggers. For example, average values of temperature, the average kinetic temperature as a measure of the energy delivered into the article per unit of time, atmospheric humidity, dewpoint values, and so forth, are regarded as climate data.

### SUMMARY

A data logger is disclosed for collecting, evaluating and displaying data, comprising: a collection unit; a storage unit; a control and evaluation unit connected to the collection and storage units for measured value recording and for evaluation, display and storage of data; a common housing for the collection, storage, and control and evaluation units; and a USB interface on the common housing for digital data exchange with an external data processing system, wherein the USB interface is configured for receiving analog measurement signals.

A method is disclosed for collecting, evaluating and displaying data, comprising: logging measured values of climate data in a data logger for storage, evaluation and display; and interfacing digital data exchange between the data logger and a data processing system external to the data logger via a USB interface provided on a housing of the data logger, wherein the USB interface also receives analog measurement signals delivered by a temperature sensor.

A method is disclosed for operating a data logger, comprising: collecting, evaluating and displaying climate data generated from measured values, the data logger being equipped with a collection unit, a storage unit and a control and evaluation unit which is connected to the other units for measured value recording and for evaluation, display and storage of data, all hardware units being located in a common housing; interfacing digital data exchange between the data logger and a data processing system external to the data logger via a USB interface; and automatically checking whether the USB interface is being operated as a digital data interface or as an analog interface for receiving analog measurement signals.

### BRIEF DESCRIPTION OF THE DRAWINGS

Other advantages and features will become apparent from the following description of exemplary embodiments of the disclosure with reference to the schematic drawings. The schematics are not to scale.

FIG. 1 shows a perspective of an exemplary data logger; and

FIG. 2 shows an exemplary block diagram of the data logger.

### DETAILED DESCRIPTION

A data logger is disclosed which allows both digital data exchange and also the connection of analog detectors and which has a compact and space-saving structure.

An exemplary data logger for collecting, evaluating and displaying climate data generated from the measured values can include a collection unit, a storage unit and a control and evaluation unit which is connected to the other units for measured value recording and for evaluation, display and storage of data. All hardware units are located in a common housing on which there is a USB interface for digital data exchange with an external data processing system. The USB interface can be operated both as a digital interface for digital data exchange and also as an analog interface for receiving analog measurement signals.

The hardware housing can be made smaller and more durable by the data logger having only a single USB interface which allows both digital data exchange and also receiving and processing of analog measurement signals. The device can, for example, therefore also be used under spatially constricted conditions. For example, a data logger equipped as disclosed herein can be used in facilities such as dry gel transports, dry ice transports and the like in which the temperature sensor is already integrated into the container. The container need have only the corresponding mechanical counterpart to the USB interface of the data logger. Omitting a separate analog interface for connection of external detectors can also be cost beneficial for the data logger. Using the USB interface also for receiving analog measurement signals obviates using separate connecting cables for transmission of analog measurement signals.

The data logger can be used in a more versatile manner; for example the data logger can be connected to any climatic test cabinet or refrigerator which is equipped with a sensor and has the corresponding mechanical counterpart to the USB interface on the data logger. The USB standard has become internationally accepted. It is durable and depending on the construction of the mechanical USB connection involves little to very little space. It goes without saying that the USB interface is not defined as the USB protocol, but that the term relates first of all to the mechanical execution of the USB interface or of the USB terminal. A USB interface is made 4-pole and thus allows connection both of classical two-pole detectors (for example simple temperature-dependent resistances) and also more complex four-pole measurement devices.

Fundamentally the data logger can be equipped with a changeover means via which the user can establish whether the USB interface is being operated as a digital interface for data communication or as an analog connection. For example, the USB interface can be connected to sensor technology which is located within the housing and via which it can be automatically interrogated as to whether the USB connection is being operated as a digital data interface or as an analog measurement data interface. The sensor technology can automatically recognize whether an external data processing system, for example a PC, or a detector, is connected to the USB interface and accordingly automatically activate the corresponding hardware units.

A very reliable method for establishing the operating mode of the USB interface involves interrogation by the sensor technology as to whether there is a feed voltage on the USB interface. The data logger itself, linked to an external data processing system, can constitute a “slave” which is supplied with a feed voltage via the “master”, the external data processing system, in order to enable the digital data exchange. If the sensor technology internal to the hardware therefore establishes that there is a feed voltage on the USB interface, a conclusion can be drawn that the external data processing system is connected, and the hardware units for digital data communication are activated. If the sensor technology conversely establishes that there is no feed voltage on the USB interface, this can have two causes. Either nothing is connected to the USB interface or there is a detector. In order to differentiate between these two possibilities, the sensor technology can initiate a measurement, for example a temperature measurement, by way of a collection unit which is equipped with a separate power supply, for example a battery. If this is successful, a conclusion can be drawn that there is an external detector and reception of analog measurement signals can be activated.

In order to be sure that, for example, for temperature monitoring a temperature sensor is in fact also connected to the USB interface, the sensor technology can be made for plausibility checking of the received analog measurement signals. The plausibility checking consists for example in that it is checked whether the received analog measurement signals are within an expected measurement value range.

The sensor technology connected to the USB interface can be made as a separate unit within the data logger. But it can be a component of the control and evaluation unit of the data logger and can be integrated into it. For example, the control unit with the sensor technology can be formed by a microcontroller.

The use of a USB interface provided on the housing of a data logger both as a digital data interface for digital data exchange and also an analog interface for receiving analog measurement signals which are delivered by a connected detector allows the hardware housing of the data logger to be made smaller and more durable. The USB interface has been repeatedly tested, has prevailed globally, is mechanically reliable and relatively insensitive. This allows still more versatile use of data loggers, especially for monitoring of climate data even under constricted space conditions.

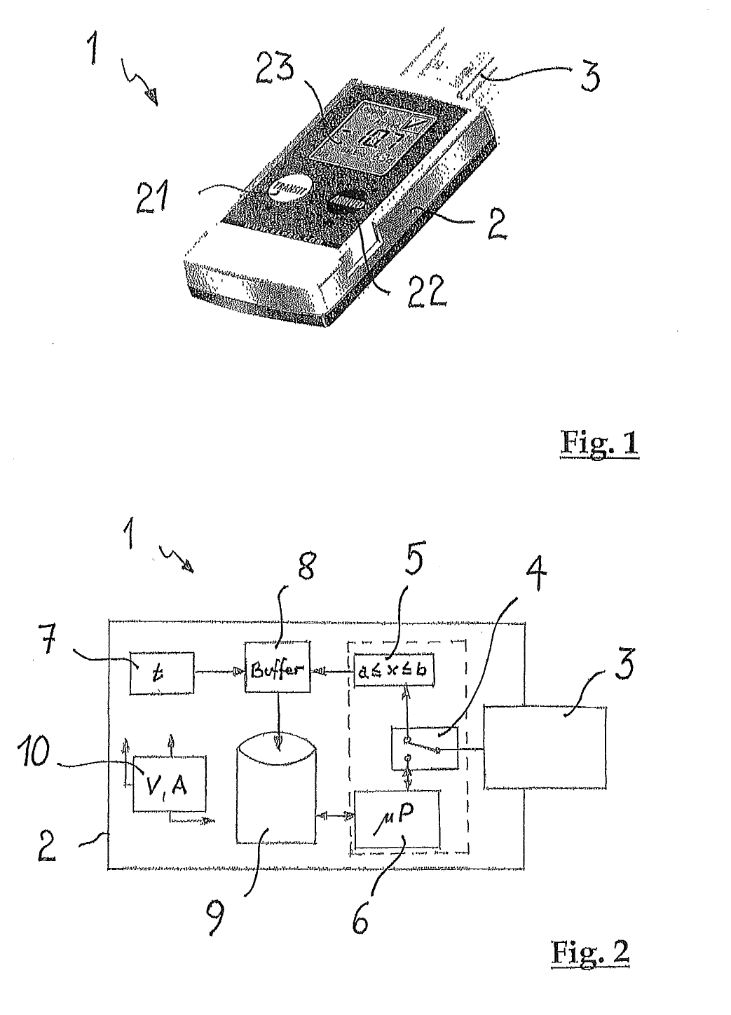

The data logger which is shown by way of example in FIG. 1 is labeled with reference number 1. The data logger 1 has a housing 2 which is equipped with a USB interface 3. On the housing there are two keypads 21, 22 via which the device can be operated. A display 23 communicates information about the state of the device, for example about the most current measured value, about activation or completion of recording of the measured values, about the remaining running time of the device as an indicator for the battery state, and so forth.

FIG. 2 shows an exemplary schematic block diagram of the data logger which is labeled with reference number 1. It has a housing 2 which is equipped with a USB interface. Within the housing 2 there is a control and evaluation unit 6 which is connected to the data storage 9. The data storage 9 is supplied with measurement data by way of a buffer storage 8 in which the signals of a timer 7 and the digitized measurement signals delivered via the USB interface 3 and sensor technology 4, 5 are synchronized. A power supply 10, for example a battery, provides the hardware unit with energy.

So that the USB interface 3 can be employed both for use as a digital data interface to an external data processing system and also for receiving analog measurement signals of a detector which is connected to the interface 3, for example for temperature measurement, the first section of the sensor technology 4, 5 which connects to the USB interface can be made as a type of separating sensor technology 4 for the signals which are present. For this purpose the separating sensor technology 4 checks whether there is a supply voltage on the USB interface 3. If it is ascertained that this is the case, the separating sensor technology 4 concludes that an external data processing system is connected to the USB interface 3 and digital data exchange is to take place. Accordingly the signal path to the evaluation and control unit 6 and to the data storage 9 is cleared. If conversely it is ascertained that there is no feed voltage, this can have two causes: either a detector is connected to the USB interface 3, or no device at all is connected. In order to differentiate between these two states, the separating sensor technology 4 attempts to receive analog measurement signals, for example temperature values. If the latter are received, the signal path to the buffer memory 8 is cleared. In order to ensure that the analog signals present are also in fact measurement signals, they are checked in a second section 5 of the sensor technology for plausibility. For this purpose it is, for example, interrogated whether the received measurement signals are within a measurement interval {a, b}. The digitized measurement signals are finally relayed together with the pertinent time data via the buffer storage 8 to the storage unit 9.

The sensor technology 4, 5 for checking of the signals which are present on the USB interface 3 can be made as a separate unit. For example, the sensor technology 4, 5 can be integrated into the control and evaluation unit 6. This is indicated in FIG. 2 by a broken border which extends over the sensor technology and the microcontroller.

The use of a USB interface 3 provided on the housing 2 of the data logger 1 both as a digital data interface for digital data exchange and also as an analog interface for receiving analog measurement signals which are supplied by a connected detector allows the device housing 2 of the data logger 1 to be made smaller and more durable. The USB interface 3 has been repeatedly tested, has prevailed globally, is mechanically reliable and relatively insensitive. This allows versatile use of data loggers, such as for monitoring of climate data even under constricted space conditions.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. Data logger for collecting, evaluating and displaying data, comprising:
a collection unit;
a storage unit;
a control and evaluation unit connected to the collection and storage units for measured value recording and for evaluation, display and storage of data;
a common housing for the collection, storage, and control and evaluation units; and
a USB interface on the common housing for digital data exchange with an external data processing system, wherein the USB interface is configured for receiving analog measurement signals.

2. Data logger as claimed in claim 1, comprising:
sensor technology connected with the USB interface and located within the housing, for automatically interrogating whether the USB connection is being operated as a digital data interface or as an analog measurement data interface.

3. Data logger as claimed in claim 2, wherein the sensor technology comprises:
a section for interrogating of a feed voltage which is present on the USB interface.

4. Data logger as claimed in claim 3, wherein the sensor technology comprises:
a second section for plausibility checking of received analog measurement signals.

5. Data logger as claimed in claim 1, wherein the control unit and evaluation unit contains the sensor technology.

6. Method for collecting, evaluating and displaying data, comprising:
logging measured values of climate data in a data logger for storage, evaluation and display; and
interfacing digital data exchange between the data logger and a data processing system external to the data logger via a USB interface provided on a housing of the data logger, wherein the USB interface also receives analog measurement signals delivered by a temperature sensor.

7. Method for operating a data logger, comprising:
collecting, evaluating and displaying climate data generated from measured values, the data logger being equipped with a collection unit, a storage unit and a control and evaluation unit which is connected to the other units for measured value recording and for evaluation, display and storage of data, all hardware units being located in a common housing;
interfacing digital data exchange between the data logger and a data processing system external to the data logger via a USB interface; and
automatically checking whether the USB interface is being operated as a digital data interface or as an analog interface for receiving analog measurement signals.

8. Method as claimed in claim 7, comprising:
checking whether there is a feed voltage on the USB interface; and
in the absence of a feed voltage, initiating a measurement process.

9. Method as claimed in claim 8, comprising:
subjecting received analog measurement signals to a plausibility check.
